(19) United States
(12) Patent Application Publication
(10) Pub. No.: US 2012/0247082 A1
(43) Pub. Date: Oct. 4, 2012

(54) Clean up - rocket

(76) Inventor: Fidel Orona, Littleton, CO (US)

(21) Appl. No.: 12/931,088

(22) Filed: Mar. 28, 2011

(51) Int. Cl. F02K 9/00; F02K 9/60

(52) U.S. Cl. 60/200.1

(57) ABSTRACT

The purpose is to develop, design a very inexpensive rocket to “clean up” the expendable debris orbiting the earth. This liter is a serious pollution of space and a threat to working satellites and the space station. Develop an inexpensive rocket engine with optimum efficiency conversion: propellants-chemicals to acquire the maximum thrust generation offering an inexpensive means to acquire low orbit to space. Parameters selected to minimize fuel consumption: by trying different hydrogen-oxygen mixture ratios.

A critical design requirement for the Clean Up space engine is the ease to start and operate reliably in the cold vacuum conditions of space. The space engine will have a reliable pressure feed system, simplicity and dependability multiple starts. Determination of optimal flight precision targeting for return of space debris: thrust vector control, acceleration and deceleration, central power source for several hours of mission duration, optimized and dedicated to acquiring a clean blue sky

This application is a continuation of Ser. No. 12/931,088; filed Jan. 25, 2011, First named of applicant: Fidel Orona; CONFIRMATION NO. 9644; responding to NOTICE TO INCOMPLETE REPLY (NONPROVISIONAL), date: Sep. 13, 2011.

### BACKGROUND OF THE INVENTION

To develop, design a very inexpensive rocket to “clean up” the expendable debris orbiting our earth. ‘About 1300 active satellites are orbiting earth and about 20000 pieces of debris (source: “By the Numbers: Earth”—Science Illustrated, March/April 2010) larger than a softball liter-orbiting the planet’. This liter is a serious pollution of space and a threat to working satellites and the space station.

### SUMMARY OF INVENTION

The first concern is to develop an inexpensive rocket engine with optimum efficiency conversion: propellants chemical energy to acquire the maximum thrust generation. The goal is to develop the most effective exhaust velocity with minimal rise to engine costs. Which would develop the second purpose, for the “Clean-Up” rocket: to offer an inexpensive means to acquire low orbit space. The performance parameters with the correction factors would be defined with the variable thrust chamber engine. This would define the final rocket engine design. Two parameters selected to minimize fuel consumption.

Successive approximations by different hydrogen-oxygen mixture ratios would be conducted: performance measured by pressure gas generation feed to optimize combustion stability. Combustion chamber cooling with minimal engine hot spots: high temperature-strength steels would be selected with the appropriate hydrogen cooling requirement passages incorporated. The selection of the best cooling method for a given thrust chamber depends on the low cost material considerations. The pressurized-gas-feed engine system has more stringent pressure limitations, but the “Clean Up-Rocket” will operate on a relative high pressure system reason propellant gas generators are utilized: the vehicle designed for such pressures. All metals will be taken close to the yield point, “work hardening” for further use of the first stage. The re-use of the first stage will be determined by metal fatigue, cracks if any, by non-destructive test methods. The design of the thrust chambers (not a typical spherical-cylindrical bell nozzle thrust chamber design) consists of three parallel pipes with injector configuration mixtures directed to a common impinging point: allowing the mixture of the propellant to be optimized, which would be low weight and simplicity concept. The design allows the specific impulse to fall very close to the theoretical calculation. The specific impulse will be proven by the first working model. The low cost nozzle would be a conical design: the fractional nozzle length runs around 96 to 98.6 percent ideal, depending on the optimum length verses weight increase. The structural walls of the combustion chamber will be driven by pressure effective cooling methods. The actual theoretical calculations for specific impulse will be developed and compared to the rocket experimental variable combustion chamber. Engine starting by pyrotechnic igniters, or spark plugs are common of the “shelf” designs. The second stage, will utilize spark plugs for repeated starts. “Combustion instability is defined in terms of amplitude of pressure fluctuations in the combustion chamber. Chamber-pressure fluctuations are always present during normal, stable operation of a rocket engine system. “These fluctuations are generally quite random, showing frequency spectra which essentially continuous with few if any, recognizable peaks. However, in case of instability, large vibratory concentrations of energy appear at one or more frequencies in the spectrum.” Hopefully the “Clean Up-Rocket can eliminate chamber-pressure fluctuations by simply lowering the operating pressure toward the second thrust parameter then regressing to its original maximum thrust performance.

The three tube injector pattern: combinations studies may be performed to develop the maximum performance; the self-impinging injector will be the back-up design, due to machine costs. Hopefully the final design will be a simple “straight” injector this will be the first attempt before moving to the self-impinging injector. The liquid oxygen/liquid hydrogen ratio at the maximum “liquid” temperature will be the goal for combustion stability. Incase instability is developed with this new engine, damping devices will be incorporated.

The design and development of controls, valves will require maturity work to the process hopefully perfecting this new system. Theoretically the goal is the open-loop control system due to simplicity utilized with the first Stage, to bring the “Grabber” second stage to its orbit designation. The closed-loop control will be necessary to guide “Grabber” to capture expendable satellites or space debris. Design of interconnecting components and mounts: propellant—Tank pressurization lines to connect the main propellant tanks to the pressuring source, the cryogenic propellant heat exchangers. Also the cooling lines to the thrust chamber cooling jacket manifold is included with the pressuring lines, excess liquid-hydrogen will be used for the coolant for the high temperature chamber. A Hydraulic system will be necessary for reaction control, the thrust chamber nozzle vanes to respond to any cross wind interference. The hydraulic system will be necessary for immediate correction of a lateral incoming load. The vertical tube heaters will be of an aluminum minimum wall design for “quick” thermal cross gradient conduction. This design will be a minimum tube diameter for smallest amount of weight increase.

Avionics highly automated ground support and space-flight systems are very reliable processing modules. High degree of on-board checkout and self-test, determination of condition and performance of engine, optimal retargeting during flight or just prior to launch: debris path and relocation of “grabbing” debris. Determination of optimal control parameters during flight precision targeting for return of space debris: main engine thrust vector control, attitude rates, acceleration and deceleration, central power source for several hours mission duration, determine by fuel supply, optimized and dedicated to acquiring a clean blue sky.

### BRIEF DESCRIPTION OF DRAWINGS

FIG. 1 shows the overall side views of Clean-Up Rocket: Demonstrates the simplicity of the rocket.

FIG. 2 shows a detail design of the Clean-Up Rocket: beginning from the right bottom corner you have the Logo description, Development—Engine variable throat and combustion chamber, overall diameter of the rocket, smaller version of main lift engine, expendable satellite and space debris—“grabber”, maneuvering space—debris deceleration vehicle, thermal insulation, pressurized system—tube propellant heaters, L—Oxygen “tanks”, L—Hydrogen “tanks”, height 60 feet, combustion gases pressurized heater manifold, oxygen and hydrogen, cross wind reaction flappers, and drives.

FIG. 3 shows the Variable Combustion Chamber and Nozzle, the “phantom” lines demonstrates the combustion throat “fully” open.

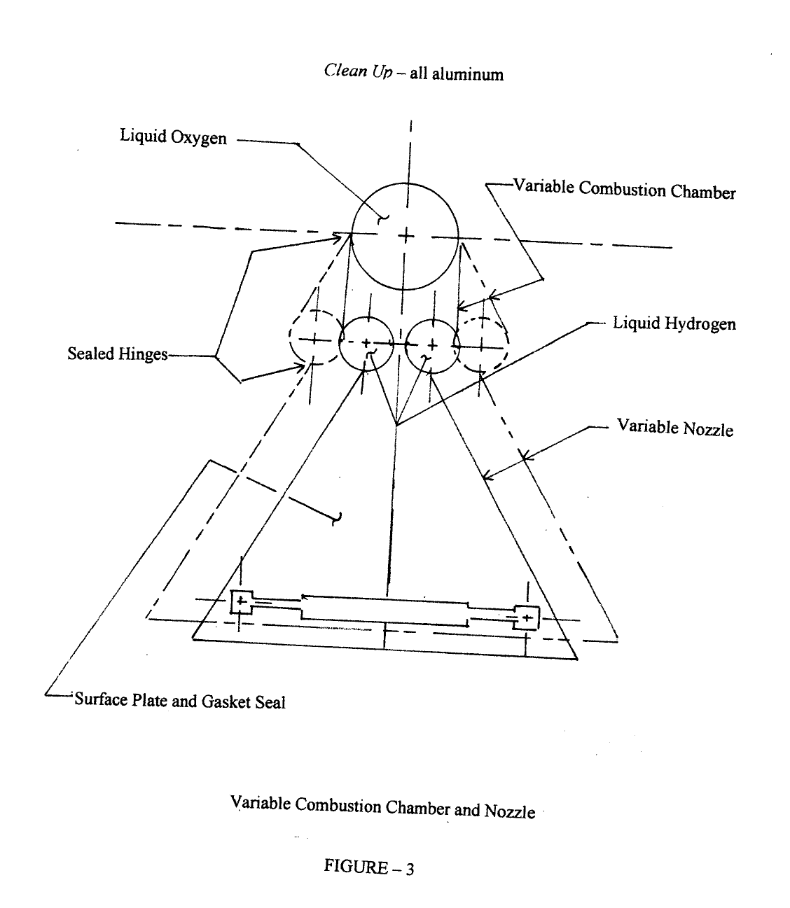

### REFERENCES

Design of Liquid Propellant Rocket Engines—Huzel and Huang, National Aeronautics and Space Administration, 1971

Transportation, Aeronautics—Abraham, Marks Standard Handbook for Mechanical Engineers, second edition; McGraw-Hill, 1966

“A Rocket Ascending under Power, Models and Nonhomogeneous equations: first order differential equations”, Differential Equations for Engineers, Creese and Haralick, McGraw-Hill, 1978

“Theoretical Performance of Rocket Propellant Combinations”—Rockwell International: Rocketdyne Chemical and Material Technology

“Shock and Vibration Handbook Handbook”, second edition; Harris and Crede, McGraw-Hill, 1976

“Heavy Lift Launch Vehicles for 1995 and Beyond”, Compiled by Ronald Toelle, George C. Marshall Space Flight Center, Alabama 35812; National Aeronautics and Space Administration, Wash., D.C. 20546

‘Design Data for Strength Analysis’, MIL-HDBK-5B, NASA Astronautic Structures Manual, 1973

“MX Assembly, Test and System Support”, General Test Plans/Procedures Ground/Flight Test Procedures Pretest Report for a Subsonic/Transonic Force and Moment Wind Tunnel Test on an 8 ¼% MX Missile Model: Martin Marietta, Fidel Orona 1980

“Low Cost Launch Vehicle Study”, submitted to NASA Headquarters Director, Transportation Systems, Code MTV, Washington, DC; Kendrick and Dergarabedian, TRW Systems Group, 1969

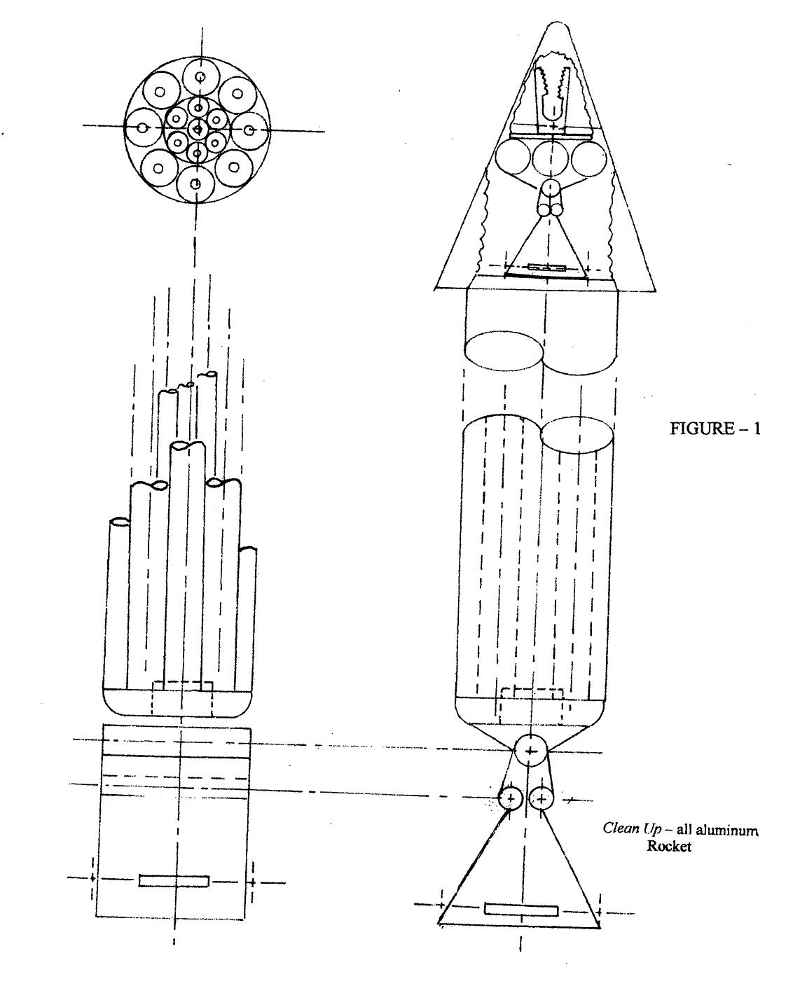

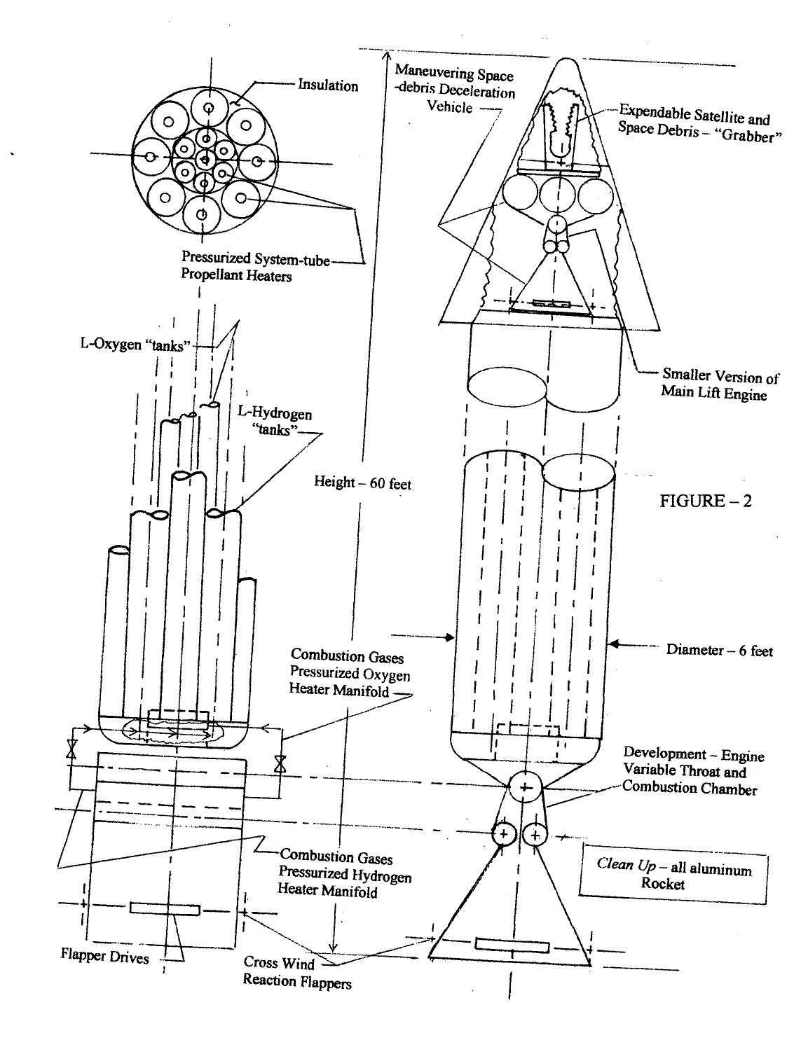

1. I claim a clean up rocket.
a. A structure with propellant tubes for the oxidizer and fuel to propel to earth orbit vacuum space and propellant tanks to maneuver second stage towards higher space debris, see FIG. 1.
b. An engine mounted on said propellant tubes, see FIG. 2, for producing translational energy to low earth orbit, and a smaller engine mounted to propel to higher earth orbit, and
c. means for controllably coupling with space debris to “dump” to a permissible site approved by the responsible Government entity.
